(19) United States
(12) Patent Application Publication
(10) Pub. No.: US 2024/0002010 A1
(43) Pub. Date: Jan. 4, 2024

(54) VEHICLE HANDLEBAR HAVING A SEAL

(71) Applicant: VEL'CO, Nantes (FR)

(72) Inventors: Pierre Regnier, Saint Herblain (FR); Romain Savouré, Nantes (FR); Johnny Smith, Nantes (FR)

(21) Appl. No.: 18/251,468

(22) PCT Filed: Oct. 27, 2021
(86) PCT No.: PCT/EP2021/079789

§ 371 Date: May 2, 2023

(30) Foreign Application Priority Data
Nov. 13, 2020 (FR) 2011638

(51) Int. Cl. B62K 21/12; B62J 3/12; B62J 43/30; B62J 45/00; B62K 21/26

(52) U.S. Cl. CPC B62K 21/12; B62J 3/12; B62J 43/30; B62J 45/00; B62K 21/26

(57) ABSTRACT

A handlebar for a vehicle. The handlebar includes: a bar having an internal volume, the bar extending longitudinally between two ends, at least an end of which, referred to as a “coupling end” has a central axis, and is open to form a passage between the internal volume and an external environment; and a watertight closure at the coupling end.

### CROSS-REFERENCE TO RELATED APPLICATIONS

This Application is a Section 371 National Stage Application of International Application No. PCT/EP2021/079789, filed Oct. 27, 2021, which is incorporated by reference in its entirety and published as WO 2022/101009 A1 on May 19, 2022, not in English.

### FIELD OF THE DISCLOSURE

The field of the invention is that of the design and manufacture of vehicle equipment with handlebar.

The invention relates more precisely to a handlebar for a vehicle, such as a bicycle, that has electronic components to enable the handlebar to send and receive electronic information.

### BACKGROUND OF THE DISCLOSURE

In the field of the invention, handlebars for vehicles produced from varied materials are known. For example, aluminium, carbon, wood or plastics material can be used for manufacturing handlebars.

A handlebar comprises a bar and a stem to which the bar is attached. To ensure use of the handlebar in complete safety, the bar and the stem of the handlebar must have sufficiently great structural strength.

To provide this structural strength, the bars of handlebars have specific designs according to the materials used for producing them. For example, to be able to have sufficient structural strength, bars made from wood or plastics material are generally solid. These bars then have high stiffness enabling them to be homologated by the various competent bodies.

Bars are also known with a hollowed structure, but produced with materials such as steel or aluminium, thus enabling the bars to have sufficient stiffness to be able to be homologated.

In the field of the invention, the bicycle handlebar described in the patent document published under the number WO 2017/207782 A1 is also known.

The handlebar described in this document is said to be “connected”, and electronic components are associated with the handlebar to confer various functions thereon. For example, a connected handlebar can exchange electronic data with a telecommunication network, or be provided with geolocation functions allowing guidance of the user or remote monitoring of the location of the handlebar.

Connected handlebars conventionally use bars with a hollowed structure. In this way, the electronics can be concealed inside the bar.

Such integration of the electronics requires protecting the latter from the external conditions to which the vehicles equipped with the handlebars are subjected.

For example, caps can be coupled to the tubular ends of the bars.

It is however particularly important for the electronics of the handlebar to be protected from rain and possible infiltrations of water.

Connected handlebars are thus provided with sealing means taking in particular the form of seals.

Use is conventionally made of seals for example coupled to end pieces intended to be inserted in the tubular ends of a bar.

Various solutions for integrating these seals and end pieces are proposed by the prior art. However, experience shows that the assemblies degrade the ability of these seals to produce a watertight connection between the bars and the bodies that carry these seals.

In addition, it has also been found that it may be difficult to reconcile the need to have sealed integration of the electronics in a bar with the novel functions that it is wished to integrate in the handlebar with the electronics.

### SUMMARY

A non-limiting exemplary embodiment of the present disclosure responds to these drawbacks.

More precisely, an exemplary embodiment proposes a handlebar provided with sealing means making it possible to effectively protect from water an internal space of the bar of the handlebar from an external space, and more precisely the sealing means of which include a seal with an optimum functioning.

A non-limiting exemplary embodiment of the present disclosure provides such a handlebar the sealing means of which allow, where applicable, efficient integration of an electronic function in the bar.

An exemplary embodiment relates to a handlebar for a vehicle, comprising:

a bar having an internal volume, the bar extending longitudinally between two ends, including at least one end referred to as the “coupling end” having a central axis, and is open to form a passage between the internal volume and an external environment;

means for the watertight closure of the coupling end, the closure means comprising a body inserted in the coupling end along the central axis, and a circumferential seal intended to produce a watertight interface between the body and the bar; characterised in that the closure means comprise:

a member for separate blocking of the body;

means for locking the blocking member in position, along the central axis, +in the coupling end,

the blocking member and the locking means forming together a stop for blocking the body with respect to translation along the central axis in the coupling end, the locking means extending along a locking axis transverse to the central axis and the blocking member being mounted so as to be able to translate freely along the locking axis with respect to the body.

By means of an exemplary embodiment of the disclosure, the handlebar has watertightness that is not disturbed by the holding in position of the body in the bar.

More precisely, the circumferential seal surrounding the body is not deformed in a manner liable to impede its performance when the body is held at its position in the bar by the blocking stop formed by the blocking member and the locking means.

In particular, the freedom in translation along the locking axis of the blocking member with respect to the body enables the body not to be subject to pressure or traction exerted by the locking means, along the locking axis, to hold the blocking member in position in the bar. The circumferential seal is thus not liable to be deformed by the action of the locking means along the locking axis.

For example, in the case where the locking means grip the blocking member against the bar, and thus exert a traction action of the blocking member along the locking axis towards the bar, then the body is not itself gripped against the bar by the locking means, and the circumferential seal is not compressed unidirectionally against the bar.

As a result the sealing function of the circumferential seal is in no way degraded, and this whatever the gripping applied on the locking means to provide the holding of the body in the inserted position in the coupling end.

According to a variant embodiment, the body has a coupling support for electronic components, the support being provided with means for centring in the internal volume of the bar.

The support is located in the internal volume of the bar and protected from the external environment by the circumferential seal.

This makes it possible to house electronic components securely in the handlebar.

These electronic components are held while being centred in the bar and protected from infiltrations of water by the circumferential seal that seals the handlebar.

According to an advantageous feature, the body comprises an end piece having an internal part intended to be inserted in the bar, the circumferential seal fitting in a circumferential groove that the internal part has, and the support is distinct from the end piece, the support being assembled on the end piece in an assembly direction transverse to the central axis.

Thus the functions relating to the support of the electronic components and to the closure produced by the end piece surrounded by the circumferential seal are dissociated. Each of these functions is thus provided by a dedicated distinct mechanical member. In addition, assembling the assembly is easier.

According to a preferential design, the support and the internal part of the end piece form together a housing accommodating the blocking member, and are each blocked with respect to translation along the central axis in the coupling end by the blocking member and the locking means.

The blocking and the locking are thus more effective.

The blocking action performed by the blocking stop, formed by the blocking member and the locking means, acts on all the elements forming the housing.

In this way, the blocking stop acts directly both on the end piece and on the support, which affords greater mechanical holding of these elements inside the bar.

According to a preferred embodiment, the end piece has an external part extending from the internal part and being intended to extend the coupling end along the central axis, the external part comprising a cavity open onto the internal volume of the bar, the cavity housing electronic components outside the internal volume of the bar.

By virtue of this embodiment, it is possible then to house the electronic components outside the internal volume of the bar and thus outside the volume delimited by the material forming the bar. This makes it possible for example to avoid enclosing all the electronic components inside the bar, which would be formed from a material impermeable to electromagnetic waves.

In particular, in the case where the bar is produced from a metal material, then it is possible to house electronic components in the cavity of the external part of the end piece which, in its case, would be produced from an electromagnetically permeable material, thus avoiding disturbances to the electronic components, even avoiding its being impossible for these electronic components to operate correctly.

Advantageously, the locking means grip the blocking member against the bar along the locking axis.

According to another advantageous feature of the handlebar, the locking means are formed by:

a threaded hole that the blocking member has;

a hole formed on a wall of the bar along the locking axis;

a screw;

the screw being intended to be inserted through the hole from the external environment and screwed into the threaded hole of the blocking member.

This design is particularly simple to implement while offering permanent locking.

According to a variant embodiment that can be envisaged, the handlebar comprises sound-emission means comprising a piezoelectric diaphragm, and the body has an opening communicating between the internal volume and the external environment, the piezoelectric diaphragm being sealingly coupled around the opening.

Such sound-emission means may for example be useful for conferring an alarm function on the handlebar.

These sound-emission means are integrated while guaranteeing sealing of the handlebar.

In this case, advantageously, the blocking member is located between the body and the external environment, and has at least one orifice communicating between the opening of the body and the external environment, the blocking member forming a protection of the piezoelectric diaphragm.

This design makes it possible to protect the piezoelectric diaphragm while guaranteeing sealing of the handlebar.

### BRIEF DESCRIPTION OF THE DRAWINGS

Other features and advantages of the invention will emerge more clearly from the reading of the following description of various preferential embodiments of the invention, given by way of illustrative and non-limitative examples, and the accompanying drawings, among which:

FIG. 1 is a schematic representation in front view of a handlebar according to an exemplary embodiment of the disclosure;

FIG. 2 is a schematic representation of a longitudinal section of an end of the handlebar according to a first embodiment;

FIG. 3 is a schematic representation in perspective from below of closure means of a bar of the handlebar according to the first embodiment, the closure means comprising a circumferential seal and a body;

FIG. 4 is a detail view illustrating more specifically the circumferential seal and means for locking the closure means according to the first embodiment;

FIG. 5 is a schematic representation in perspective from above of a support of the body according to the first embodiment;

FIG. 6 is a schematic representation in perspective from below of an end piece of the body according to the first embodiment;

FIG. 7 is a schematic representation from above of the closure means of a second embodiment of the handlebar according to the disclosure;

FIG. 8 is a schematic representation in perspective from below of the closure means illustrated by FIG. 7;

FIG. 9 is a schematic representation in a perspective from below of a blocking member of the closure means illustrated by FIGS. 7 and 8;

FIG. 10 is a schematic representation of the body of the closure means illustrated by FIGS. 7 and 8;

FIG. 11 is a simplified schematic representation of a longitudinal section of an end of the handlebar according to the second embodiment.

### DETAILED DESCRIPTION OF ILLUSTRATIVE EMBODIMENTS

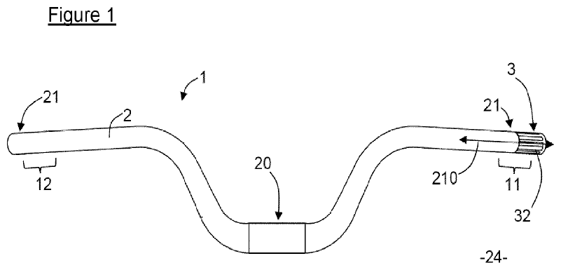

With reference to FIG. 1, a handlebar 1 according to an exemplary embodiment of the disclosure is shown.

The handlebar 1 is a handlebar for a vehicle.

The vehicles comprising the handlebar 1 according to the invention can in particular be bicycles or scooters.

The handlebar 1 according to an exemplary embodiment of the disclosure is more particularly adapted for vehicles provided with electric propulsion.

With reference to FIG. 1, the handlebar 1 comprises a bar 2 that extends longitudinally between two ends.

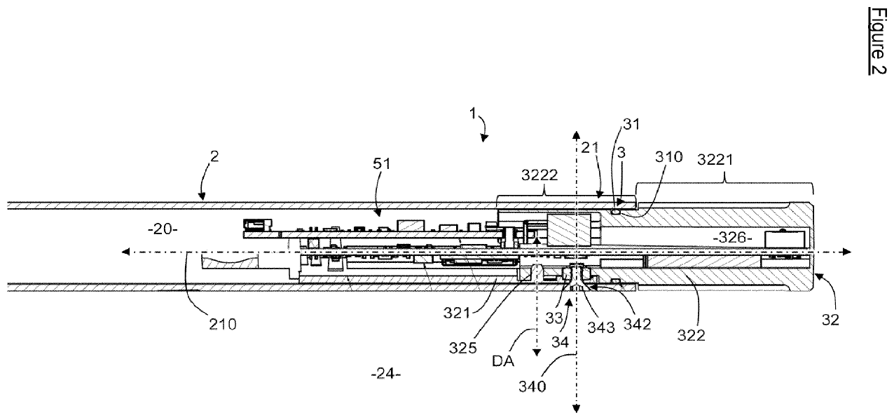

As illustrated by FIGS. 1 and 2, this bar 2 is hollow and has an internal volume 20.

This bar 2 is in particular formed by a tube.

At least one of the two ends of the bar 2 is a “coupling end 21”.

According to the embodiment illustrated by FIGS. 1 and 2, the bar has two coupling ends 21. These two coupling ends 21 take different forms as detailed hereinafter.

According to another embodiment that is not illustrated, the bar 2 has a single coupling end 21.

With reference to FIG. 1, the handlebar 1 also has two preferential gripping zones that are intended to be gripped by hand during use of the handlebar 1.

These two preferential gripping zones can for example be equipped with sheaths made from foamed material to make gripping thereof more pleasant.

In particular, the handlebar 1 has a first gripping zone 11 incorporating the coupling end 21 located to the right of the figure, and a second gripping end 12 located in the immediate vicinity of the other coupling end 21 of the bar 2, which is located to the left of the figure.

The bar 2 has, at least at the or each coupling end 21, a circular cross section.

Each coupling end 21 of the bar 2 has a central axis 210 (the central axis 210 being shown for only one of the ends on FIG. 1).

These coupling ends 21 are open and form a passage between the internal volume 20 of the bar 2 and an external environment 24.

With reference to FIGS. 1, 2, 3, 7 and 8, the handlebar 1 according to an exemplary embodiment of the disclosure also comprises means 3 for closing each coupling end 21. These closure means 3 are watertight.

These closure means 3 can take various forms.

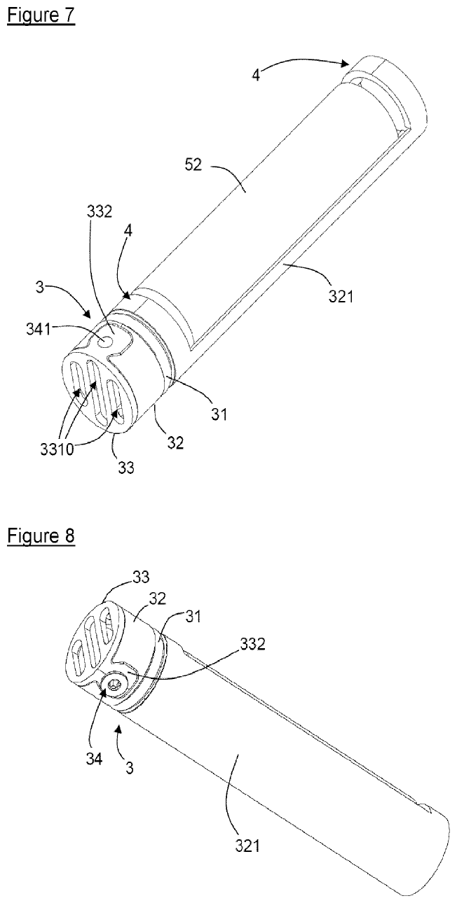

A first embodiment of these closure means 3 is illustrated by FIGS. 1 to 6, and a second embodiment of the closure means 3 is illustrated by FIGS. 7 to 10.

The first embodiment of the closure means 3 is in particular applicable to the coupling end 21 illustrated to the right of FIG. 1, and the second embodiment of the closure means 3 is applicable to the coupling end 21 illustrated to the left of FIG. 1.

As illustrated by FIG. 2, these closure means 3 each comprise a body 32 inserted in the coupling end 21 along the central axis 210.

In other words, the body 32 is inserted in the coupling end 21 along the central axis 210, through the passage of the coupling end 21 between the internal volume 20 and the external environment 24.

The closure means 3 also comprise a circumferential seal 31 that is intended to produce a sealed interface between the body 3 and the bar 2 as illustrated by FIG. 2.

According to the present embodiments in FIGS. 2 to 10, the body 32 has a circumferential groove 310 accommodating the circumferential seal 31.

The circumferential grooves 310 of these two embodiments are in particular annular, and the circumferential seals 310 are O-ring seals.

The closure means 3 also comprise a blocking member 33 that is distinct from the body 32, as well as means 34 for locking the blocking member 33 in position, along the central axis 210, in the coupling end 21.

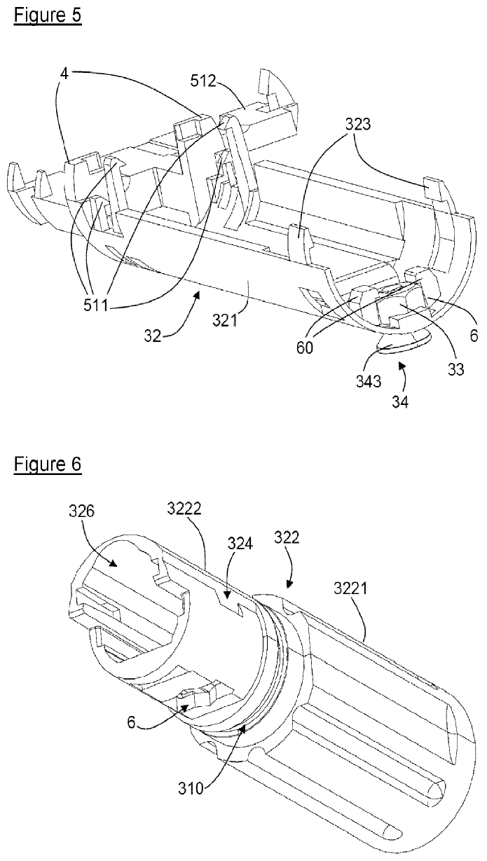

According to the embodiment illustrated by FIGS. 2 and 5, the blocking member 33 takes the form of a nut.

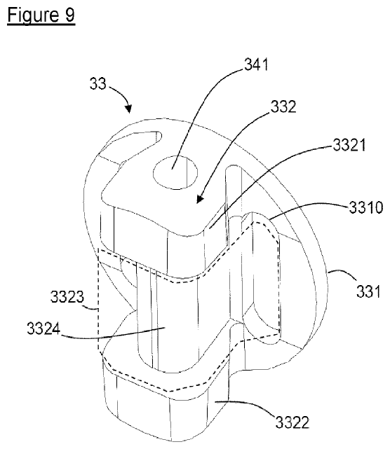

With reference to the other embodiment illustrated by FIGS. 5 and 9, the blocking member 33 takes the form of a cap comprising a partially perforated protective disc 331 and a sliding tenon 332 extending from a lateral face 3311 of the protective disc 331.

According to this embodiment, the sliding tenon 332 comprises a top part 3321 and a bottom part 3322 connected to each other by a rod 3324. This sliding tenon 332 has in this case a hollow 3323 around the rod 3324, as detailed hereinafter.

With reference to FIG. 2, the blocking member 33 and the locking means 34 form together a stop for blocking the body 32 with respect to translation along the central axis 210 in the coupling end 21.

The locking means 34 extend along a locking axis 340.

The locking axis 340 is transverse to the central axis 210. More specifically, the locking axis 340 is perpendicular to the central axis 210.

The blocking member 33 is mounted so as to be free in translation along the locking axis 340 with respect to the body 32.

More precisely, the blocking member 33 has a movement along the locking axis 340 with respect to the body 32 and can in particular be translated outside the body 32 in at least one direction along the locking axis 340, in particular in the direction of the locking means 34.

With reference to FIGS. 5, 6 and 7, the body 32 has a housing 6 for accommodating the blocking member 33.

The accommodation housing 6 of the embodiment illustrated by FIGS. 7 to 10 is in particular formed by a mortise in which the sliding tenon 332 can slide.

This mortise extends along the locking axis 340.

The mortise, and therefore the housing 6, comprises more specifically two parts, including a top part 61 and a bottom part 62. The top part 61 and the bottom part 62 of the housing 6 are complementary in shape to the top part 3321 and the bottom part 3322 of the sliding tenon 332. This allows the insertion of the sliding tenon 332 by sliding in the mortise, and the blocking thereof with respect to rotation about the locking axis 340 or the translation thereof with respect to the body 32 in directions transverse to the locking axis 340.

As illustrated on FIG. 2, the locking means 34 are formed by:

a threaded hole 341 (shown on FIGS. 7 and 9) that the blocking member 33 has;

a hole 342 provided on a wall of the bar 2, along the locking axis 340;

a screw 343 that is intended to be inserted through the hole 342 from the external environment 24, and to be screwed in the threaded hole 341 of the blocking member 33.

More specifically, the nut (blocking member 33) of the embodiment illustrated by FIGS. 2 and 5 has the threaded hole 341.

With reference to the embodiment illustrated by FIGS. 7 to 9, the sliding tenon 332 has at its centre the threaded hole 341. According to this embodiment, an internal thread of the threaded hole 341 can be formed during the screwing of the screw 343.

The locking means 34 are thus in particular designed, according to the two embodiments illustrated, to grip the blocking member against the bar along the locking axis.

Other embodiments of the locking means 34 can be envisaged. For example, the locking means can be formed by a worm positioned inside the blocking member and intended to apply a pressure to an internal face of the bar. This worm must then be accessible and actuatable from the outside through the coupling end 21.

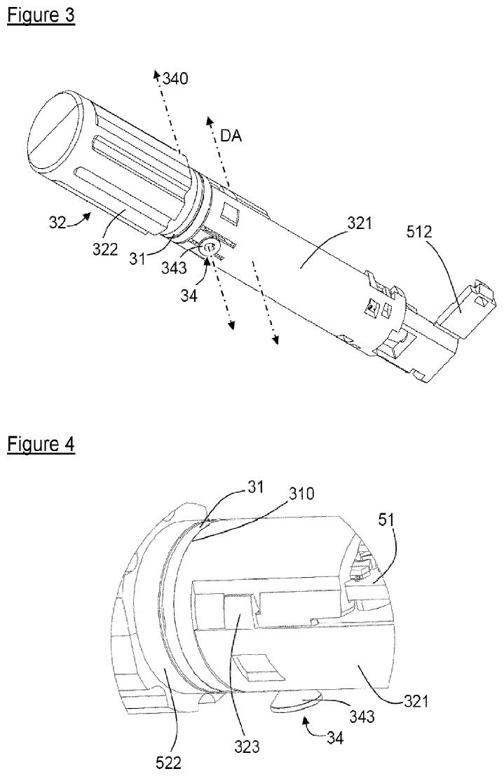

With reference to FIGS. 3, 5, 7, 8 and 10, the body 32 has a support 321 for coupling electronic components.

The support 321 comprises in particular a half of a hollowed-out cylinder. The support 321 can thus receive within it electronic components.

With reference to FIG. 2, the support 321, according to this embodiment, receives electronic cards 51.

As illustrated by FIG. 5, the support 321 has hooks 511 for holding the electronic cards 51 in position on the support 321.

According to FIGS. 3 and 5, the support 321 also has a flap 512 able to rotate on the support 321. This flap 512 is intended to be folded over onto the electric wires extending from the electronic cards, and to hold them captive.

With reference to FIGS. 7 and 8, the coupling support 321 receives an electric battery 52 in a shape that is essentially cylindrical of revolution.

The supports 321 are furthermore provided with means 4 for centring in the internal volume 20 of the bar 2.

These centring means 4 are formed by extensions of the supports 321 at least partially matching the shape of an internal surface of the bar 2.

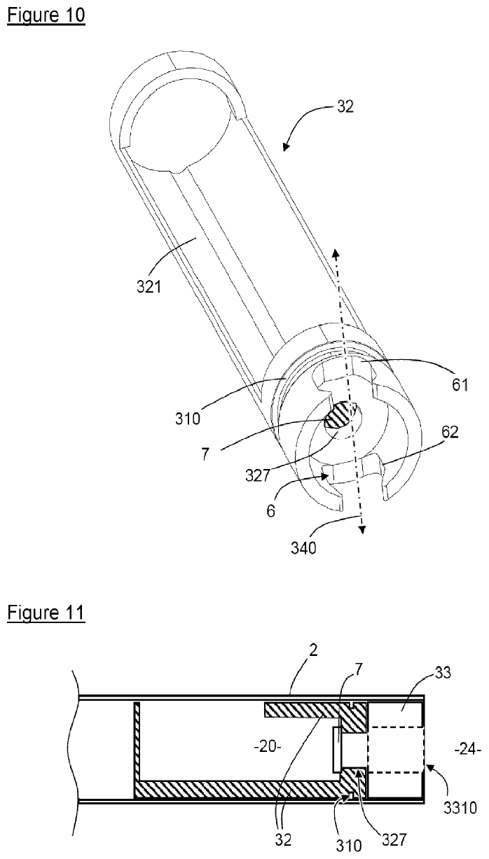

With reference to FIGS. 7 and 10, the centring means 4 are in particular formed by arches extending from the support 321. These arches and the support 321 have together, in a cross section, an annular contour.

According to the embodiment illustrated by FIGS. 2 to 6, the body 32 comprises an end piece 322 distinct from the support 321.

The support 321 is assembled on the end piece 322 in an assembly direction DA transverse to the central axis 210.

More specifically, the end piece 322 is fitted into and clipped onto the support 321.

For this purpose, the support 321 has two clipping hooks 323 complementary to notches 324 that the end piece 322 has.

As visible on FIG. 2, the support 321 furthermore has a stub 325 extending in the assembly direction DA and in which the end piece 322 fits.

The end piece 322 has an internal part 3222 intended to be inserted in the bar 2, and an external part 3221 extending from the internal part 3222 and which is intended to extend the coupling end 21 along the central axis 210.

As can be observed on FIGS. 2 and 6, the end piece 322, and more specifically the external part 3221 of the end piece 322, comprises a cavity 326 open onto the internal volume 20 of the bar 2.

This cavity 326 is intended to house some of the electronic components outside the internal volume 20 of the bar 2.

As illustrated by FIGS. 2 to 4, as well as by FIG. 6, the internal part 3222 of the end piece 322 has the circumferential groove 310.

With reference to FIGS. 7, 8 and 10, the body 32 and its support 321 are in a single piece.

With reference to FIGS. 2, 5 and 6, and as explained previously, the body 32 has a housing 6. More specifically, the support 321 and the internal part 3222 of the end piece 322 each have a part of the housing 6 accommodating the blocking member 33. These parts of the accommodating housing 6 are complementary to each other and are both in the cavity of the blocking member 33.

Each of the support 321 and end piece 322 is blocked with respect to translation along the central axis 210 in the coupling end 21 by the blocking member 33 and the locking means 34.

This is because, as illustrated by FIG. 5, the support 321 has a part of the housing 6 in which the blocking member 33 can be inserted and held. In this part of the housing 6, the blocking member 33, in other words the nut, can freely translate towards the outside, along the locking axis 340, when the support 321 is not inserted in the internal volume 20 of the bar 2.

According to this embodiment, the support 32 comprises two arms 60 blocking the translation of the nut in an insertion direction to a predetermined distance, along the locking axis 340, and thus preventing it from being lost inside the internal volume 20 of the bar 2.

With reference to FIG. 6, the end piece 322 has an opening at the cavity of the nut of the means of the blocking member 33 and hooks that the support 321 has.

This opening forms the housing part 6 that the end piece 322 has.

When the end piece 322 is fitted on the support 321, then the blocking member 33 can be inserted in the housing 6, and the assembly can be inserted through the passage formed by the coupling end 21, inside the internal volume 20 of the bar 2.

With reference to the embodiment illustrated by FIGS. 7 to 11, the handlebar 1 comprises sound-emission means (not shown) comprising a piezoelectric diaphragm 7 (illustrated on FIGS. 10 and 11).

For this purpose, the body 32 has an opening 327 communicating with the internal volume 20 of the bar 2 and the external environment 24. The piezoelectric diaphragm 7 is then sealingly coupled around the opening 327 of the body 32. For example, the diaphragm can be glued to the periphery of the opening 327.

More precisely, this opening 327 is located on a wall of the body 32 extending in the vicinity of the circumferential groove 310.

According to the embodiment illustrated by FIGS. 7 to 9, and with reference more specifically to FIGS. 10 and 11, the blocking member 33 is located between the body 32 and the external environment 24. This blocking member 33, and more specifically the protective disc 331, has orifices 3310 that communicate between the opening 327 of the body 32 and the external environment 24.

With reference to FIGS. 7 to 10, and as explained previously, the blocking member has a recess 3323, located between the top part 3321 and the bottom part 3322 of the sliding tenon 332, and around the rod 3224. This recess 3323 makes it possible, once the blocking member 33 is coupled to the body 32, to form a communicating space between the orifices 3310 and the opening 327 of the body 32.

This enables a soundwave produced by the piezoelectric diaphragm 7 at the opening 327 of the body 32 to propagate to the external environment 24 through the orifice 3310.

The blocking member 33 then forms a protection for the piezoelectric diaphragm 7.

Although the present disclosure has been described with reference to one or more examples, workers skilled in the art will recognize that changes may be made in form and detail without departing from the scope of the disclosure and/or the appended claims.

1. A handlebar for a vehicle, comprising:
a bar having an internal volume, the bar extending longitudinally between two ends, including at least one end referred to as a coupling end having a central axis, and is open to form a passage between the internal volume and an external environment;
a watertight closure at the coupling end, the closure means comprising:
a body inserted in the coupling end along the central axis,
a circumferential seal which produces a watertight interface between the body and the bar;
a blocking member providing a separate blocking of the body;
a lock means for locking the blocking member in position, along the central axis, in the coupling end,
the blocking member and the lock form together a stop for blocking the body with respect to translation along the central axis in the coupling end, the lock extending along a locking axis transverse to the central axis and the blocking member being mounted so as to be able to translate freely along the locking axis with respect to the body.

2. The handlebar according to claim 1, wherein the body has a support for coupling electronic components, the support being provided with centering elements for centring in the internal volume of the bar.

3. The handlebar according to claim 2, wherein the body comprises an end piece having an internal part insertable in the bar, the circumferential seal fitting in a circumferential groove that the internal part has, and the support is distinct from the end piece, the support being assembled on the end piece in an assembly direction transverse to the central axis.

4. The handlebar according to claim 3, wherein the support and the internal part of the end piece form together a housing accommodating the blocking member, and are each blocked with respect to translation along the central axis in the coupling end by the blocking member and the lock.

5. The handlebar according to claim 3, wherein the end piece has an external part extending from the internal part and extending the coupling end along the central axis,
the external part comprising a cavity open on the internal volume of the bar, the cavity housing electronic components outside the internal volume of the bar.

6. The handlebar according to claim 1, wherein the lock grips the blocking member against the bar along the locking axis.

7. The handlebar according to claim 6, wherein the lock is formed by:
a threaded hole that the blocking member has;
a hole formed on a wall of the bar along the locking axis;
a screw;
the screw being insertable through the hole from the external environment and screwable into the threaded hole of the blocking member.

8. The handlebar according to claim 1, wherein the handlebar comprises a sound emitter comprising a piezoelectric diaphragm, and the body has an opening communicating between the internal volume and the external environment, the piezoelectric diaphragm being sealingly coupled around the opening.

9. The handlebar according to claim 8, wherein the blocking member is located between the body and the external environment, and has at least one orifice communicating between the opening of the body and the external environment, the blocking member forming a protection of the piezoelectric diaphragm.
